(19) United States
(12) Patent Application Publication
(10) Pub. No.: US 2020/0114883 A1
(43) Pub. Date: Apr. 16, 2020

(54) Snow Removal Device For A Large Vehicle

(71) Applicant: Jan Orlando, Peekskill, NY (US)

(72) Inventor: Jan Orlando, Peekskill, NY (US)

(21) Appl. No.: 16/601,675

(22) Filed: Oct. 15, 2019

Related U.S. Application Data
(60) Provisional application No. 62/744,782, filed on Oct. 12, 2018.

(51) Int. Cl. B60S 3/04

(52) U.S. Cl. CPC B60S 3/045

(57) ABSTRACT

A snow removal device for a large vehicle. The device includes an elongated member. The elongated member has a first end that is placed opposite of a second end. The elongated member is large enough to extend over the roof of a large vehicle, such as a bus or a trailer. The elongated member has a number of bristles that are attached to the bottom surface of the elongated member. A first handle is placed on the first end of the elongated member. A second handle is placed on the second end of the elongated member. The first handle and the second handle hang downward from the elongated member.

### CROSS REFERENCE TO RELATED APPLICATIONS

This application claims the benefit of U.S. Provisional Application No. 62/744,782 filed on Oct. 12, 2018. The above identified patent application is herein incorporated by reference in its entirety to provide continuity of disclosure.

### BACKGROUND OF THE INVENTION

The present invention relates to a snow removal device for use with a large vehicle. More specifically, the present invention is a mechanical device that will allow a user to push snow off of a roof of a large vehicle or a trailer.

Large vehicles are an essential part of modern life. Buses not only carry children to school, but transit buses take individuals to places they need to go for work or for pleasure. Trailers are utilized to protect goods while they are shipped from their origination destinations to their delivery destinations. Many of these vehicles are utilized in areas that receive snowfall. When snow falls onto these vehicles, it must be removed both for the safety of the large vehicle and operator (as well as the vehicles and operators travelling on the same roads as the large vehicle), and to maximize the fuel and operational efficiency of the vehicles.

Typically, snow rakes, snow shovels or other similar tools are utilized to remove snow from the roofs of these vehicles. These devices, however, are difficult to maneuver and require a significant amount of upper body strength. Additionally, these tools are not designed to reach the high areas of large vehicles. Many individuals may attempt to climb on top of the vehicle, which is unstable and unsafe. Therefore, there is a need amongst the known art for a device that will assist individuals in removing snow from the roof of a high clearance vehicles.

### SUMMARY OF THE INVENTION

In view of the foregoing disadvantages inherent in the known types of snow removal systems and methods for large vehicles now present in the prior art, the present invention provides a snow removal device for a large vehicle wherein the same can be utilized for providing convenience for the user when removing snow from the roof of a large vehicle.

The present system comprises an elongated member. The elongated member is defined by a first end disposed oppositely of a second end. The elongated member is dimensioned to entirely traverse a roof of a large vehicle, such as a bus or a trailer. A plurality of bristles extends outward and downward from a bottom surface of the elongated member. A first handle is disposed on a first end of the elongated member. A second handle is disposed on a second end of the elongated member. The first handle and the second handle extend downward from the elongated member, such that an individual standing on the ground next to the large vehicle can move the elongated member by engaging he first handle or the second handle.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the snow removal device for a large vehicle.

FIG. 2 shows a perspective view of an alternate embodiment of the snow removal device for a large vehicle.

FIG. 3 shows a cross-sectional view of an alternate embodiment of the snow removal device for a large vehicle.

FIG. 4 shows a perspective view of an embodiment of the snow removal device for a large vehicle in use.

### DETAILED DESCRIPTION OF THE INVENTION

Reference is made herein to the attached drawings. Like reference numerals are used throughout the drawings to depict like or similar elements of the snow removal device for a large vehicle. The figures are intended for representative purposes only and should not be considered to be limiting in any respect.

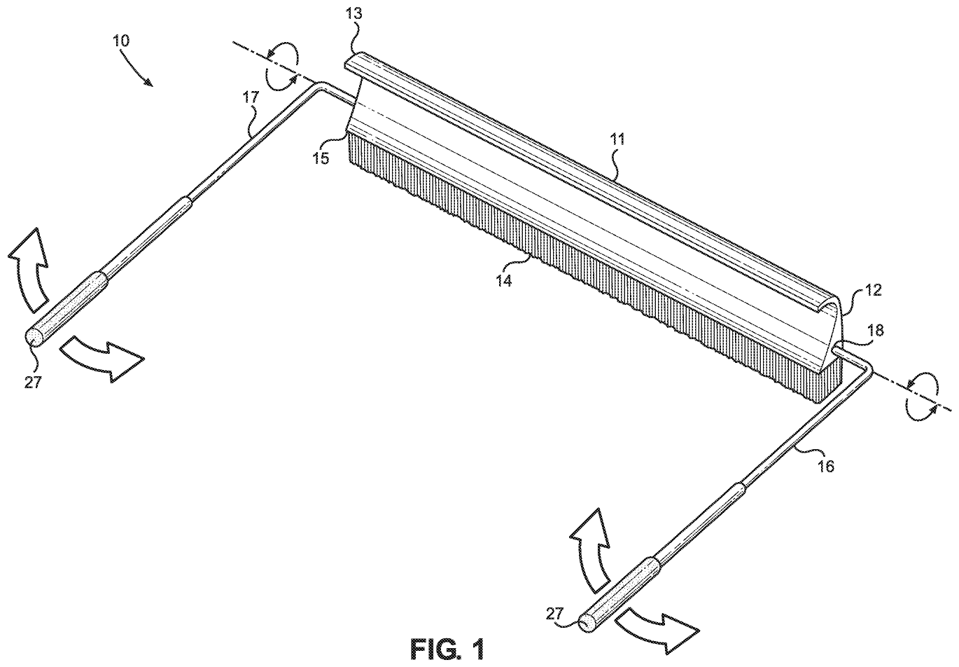

Referring now to FIG. 1, there is shown a perspective view of an embodiment of the snow removal device for a large vehicle. The snow removal device 10 comprises an elongated member 11. The elongated member 11 has a first side 12 that is disposed oppositely a second side 13. The elongated member 11 is dimensioned and configured to entirely traverse a roof of a large vehicle. As such, snow may be removed from the entirety of the roof of the large vehicle. In one embodiment, the elongated member 11 is made of a flexible material. As such, the elongated member 11 can flex to adapt to the exact shape or curvature of the large vehicle that is being cleared of snow. The elongated member 11 may be made of any suitable material for the desired purpose that is durable and light in weight. In one embodiment, the elongated member is made of aluminum, such that the elongated member is able to be moved by an individual effectively along the roof of the large vehicle with ease.

A plurality of bristles 14 extend downward from a bottom surface 15 of the elongated member 11. The plurality of bristles 14 are configured to push snow off of the rood of the large vehicle, as pressure is applied. As the elongated member 11 is pushed along the roof of the large vehicle, the plurality of bristles 14 will contact the roof such that any small crevices or cavities in the roof will be cleared of snow or ice.

In one embodiment, the plurality of bristles 14 are substantially rigid, such that they are capable of exerting tensile force when they are brought into contact with crevices, cavities, chunks of ice, compressed snow, or other obstacles atop the roof of the large vehicle. The plurality of bristles 14 should be at least partially flexible, however, such as to prevent damage to the roof of the large vehicle via scraping. For example, in one embodiment, the plurality of bristles 14 may be made of plastic. In one embodiment, a central portion of the plurality of bristles 14 comprises bristles of a lesser stiffness than a pair of peripheral portions of the plurality of bristles 14. As such, vehicles that have a raised central portion, such as vehicles with rounded roofs, will be more effectively cleared of snow.

A first handle 16 is disposed on the first end 12 of the elongated member 11. The first handle 16 extends downward from the elongated member 11, such that it is accessible by an individual standing on the ground next to a large vehicle. Additionally, a second handle 17 is disposed on the second end 13 of the elongated member 11. The second handle 17 also extends downward from the elongated member 11, such that it is accessible by an individual standing on the ground next to the large vehicle. In the illustrated embodiment, the first handle 16 is rotatably mounted upon the first end 12 of the elongated member 11 and the second handle 17 is rotatable mounted upon the second end 13 of the elongated member 11. As such, the first handle 16 and the second handle 17 are angularly adjustable relative to the elongated member 11. Specifically, the first handle 16 and the second handle 17 are rotationally movable around the interfaces 18 defined by the connection point of the first handle 16 and the second handle 17 to the elongated member 11. In the shown embodiment, the first handle 16 and the second handle 17 are symmetrically identical to one another. Furthermore, in the illustrated embodiment, each of the first handle 16 and the second handle 17 comprises a grip 27. The grip 27 is configured to allow the user to more effectively grasp the first handle 16 or the second handle 17, such as when the individual must apply increased pressure to the elongated member 11.

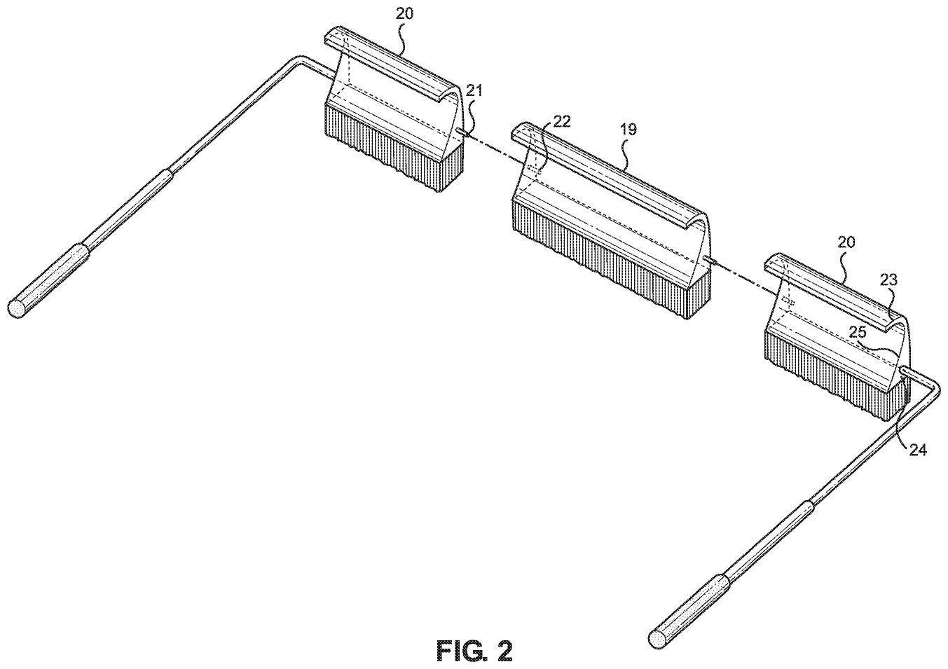

Referring now to FIG. 2, there is shown a perspective view of an alternate embodiment of the snow removal device for a large vehicle. In the illustrated embodiment, the elongated member is composed of a plurality of segments. Each segment of the plurality of segments is removably attached to each other. Specifically, as shown, the plurality of segments comprises a central segment 19 disposed between a pair of end segments 20. In further embodiments, more than one central segment 19 may be provided. The segments of the plurality of segments 19, 20 are securable to one another via a fastener. In the illustrated embodiment, the fastener comprises a snap fit connection consisting of a peg 21 that is dimensioned to tensionably rest in an aperture 22. As such, the plurality of segments 19, 20 will be held together when the snow removal device is utilized to remove snow from a large vehicle. In some embodiments, the bristles of the central portions are less rigid.

Additionally, in the illustrated embodiment, the elongated member defines an inward arcuate curve 25 between the bottom surface 25 of the elongated member and the top surface 23 of the elongated member. As such, when the elongated member is moved along a roof of a large vehicle, snow will be more effectively and efficiently displaced. Additionally, the shape forms a wedge on the bottom surface 25 such that ice chunks or denser snow can be more easily removed.

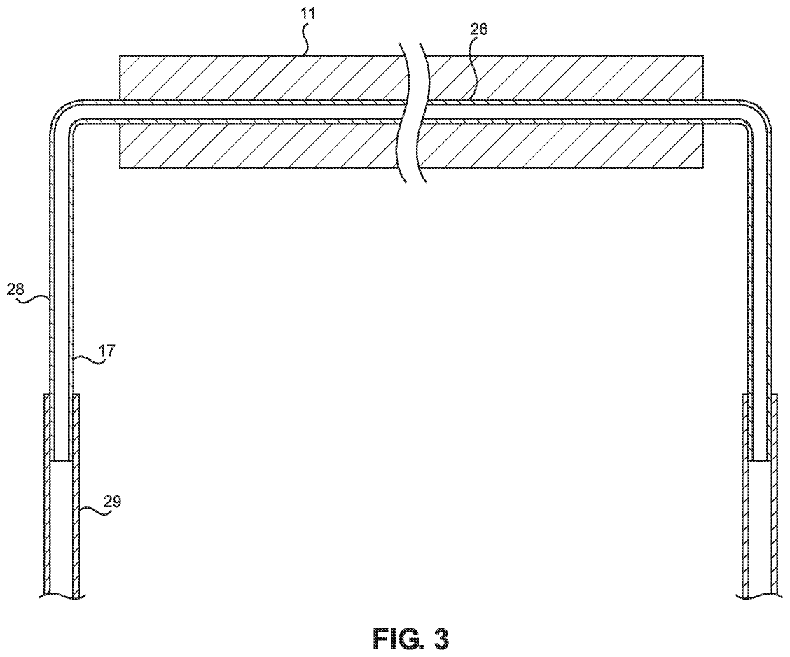

Referring now to FIG. 3, there is shown a cross-sectional view of an alternate embodiment of the snow removal device for a large vehicle. In the illustrated embodiment, the first handle and the second handle 17 are formed of a single handle member. The single handle member extends through a channel 26 formed by the elongated member 11. In some embodiments, the single handle member is in operable connection with a locking mechanism. As such, the position of the single handle member can be secured when an individual is using the snow removal device or is storing the snow removal device.

In some embodiments, such as the shown embodiment, the first handle and the second handle 17 are of a telescopic configuration. In such an embodiment, the first handle and the second handle 17 comprise a first member 28 slidably engaged with a second member 29. The second member 29 is hollow, such that the first member 28 can be slidably engaged therein. As such, the individual using the snow removal device will be able to adjust the length of the first handle and the second handle 17 to accommodate vehicles of a variety of heights.

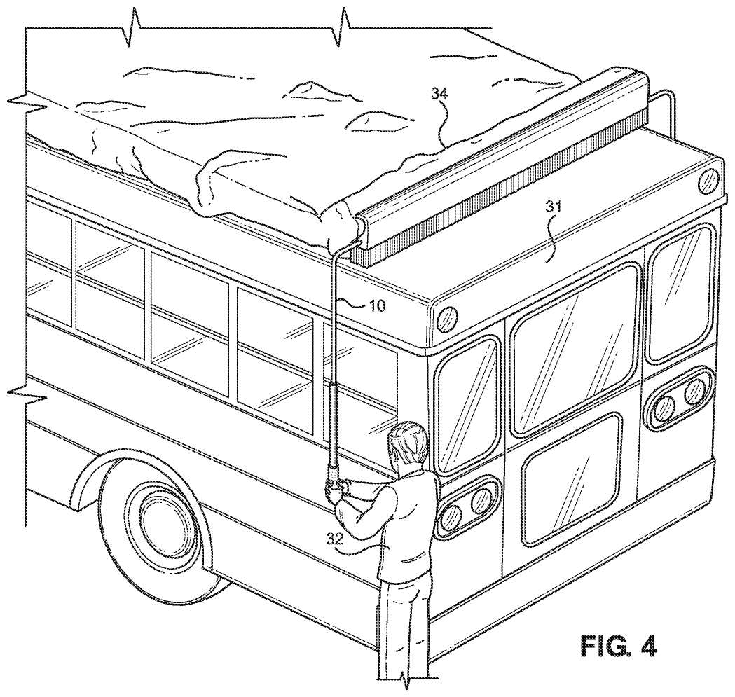

Referring now to FIG. 4, there is shown a perspective view of an embodiment of the snow removal device for a large vehicle. In use, the snow removal device 10 is placed over top of the ceiling of a large vehicle 31. The snow removal device 10 is of a suitable length, such that it can entirely traverse the ceiling of the large vehicle 31. In the illustrated embodiment, the snow removal device 10 is placed upon a rear end of a school bus 31. Once placed, an individual 32 can then utilize a handle to laterally move the snow removal device 10 along the ceiling of the large vehicle 31. As the snow removal device 10 laterally moves along the ceiling, snow 34 or another form of accumulation will be pressed or otherwise relocated from the ceiling of the large vehicle 31.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1) A snow removal device for a large vehicle, comprising:
an elongated member having a first end and a second end;
a plurality of bristles extending downward from a bottom surface of the elongated member;
a first handle disposed on the first end of the elongated member;
a second handle disposed on a second end of the elongated member; and
the first handle and the second handle facing downward from the elongated member.

2) The snow removal device for a large vehicle of claim 1, wherein the first handle and the second handle are angularly adjustable relative to the elongated member.

3) The snow removal device for a large vehicle of claim 1, wherein a central portion of the plurality of bristles are of a lesser stiffness than a pair of peripheral portions of the plurality of bristles.

4) The snow removal device for a large vehicle of claim 1, wherein the elongated member is made of a flexible material.

5) The snow removal device for a large vehicle of claim 1, wherein the first handle and the second handle are of a telescopic configuration.

6) The snow removal device for a large vehicle of claim 1, wherein the first handle and the second handle are formed of a single handle member, wherein the single handle member extends through a channel disposed in the elongated member.

7) The snow removal device for a large vehicle of claim 6, wherein the single handle member is in operable connection with a locking mechanism.

8) The snow removal device for a large vehicle of claim 1, wherein the elongated member is composed of a plurality of segments that are removably attachable to each other, including a pair of end segments and at least one central segment.

9) The snow removal device for a large vehicle of claim 8, wherein the plurality of segments is securable to each other via a plurality of fasteners.

10) The snow removal device for a large vehicle of claim 9, wherein the plurality of fasteners is a plurality of snap fit connections.

11) The snow removal device for a large vehicle of claim 1, wherein the first handle and the second handle are symmetrically identical.

12) The snow removal device for a large vehicle of claim 1, further comprising a pair of collars disposed on the first end and the second end of the elongated member.

13) The snow removal device for a large vehicle of claim 1, wherein the elongated member comprises an inward, arcuate curve between the bottom surface and the top surface thereof.

14) The snow removal device for a large vehicle of claim 1, wherein a grip is disposed on a distal end of each of the first handle and the second handle.

15) A snow removal device for a large vehicle, comprising:
an elongated member having a first end and a second end;
wherein the elongated member is made of a flexible material;
a plurality of bristles extending downward from a bottom surface of the elongated member;
a first handle disposed on the first end of the elongated member;
a second handle disposed on a second end of the elongated member;
the first handle and the second handle facing downward from the elongated member;
wherein the first handle and the second handle are angularly adjustable relative to the elongated member;
wherein the first handle and the second handle comprise a locking mechanism configured to secure the angle at which the first handle and the second handle are disposed.

16) A snow oval device for a large vehicle, comprising:
an elongated member having a first end and a second end;
a plurality of bristles extending downward from a bottom surface of the elongated member;
a first handle disposed on the first end of the elongated member;
a second handle disposed on a second end of the elongated member;
the first handle and the second handle facing downward from the elongated member;
wherein the first handle and the second handle are angularly adjustable relative to the elongated member;
wherein the first handle and the second handle are formed of a single handle member, wherein the single handle member extends through a channel disposed in the elongated member;
wherein the single handle member is in operable connection with a locking mechanism.
